(19) United States
(12) Patent Application Publication
(10) Pub. No.: US 2024/0111988 A1
(43) Pub. Date: Apr. 4, 2024

(54) NEURAL GRAPHICAL MODELS FOR GENERIC DATA TYPES

(71) Applicant: Microsoft Technology Licensing, LLC, Redmond, WA (US)

(72) Inventors: Harsh SHRIVASTAVA, Redmond, WA (US); Urszula Stefania CHAJEWSKA, Issaquah, WA (US)

(21) Appl. No.: 17/949,710

(22) Filed: Sep. 21, 2022

(51) Int. Cl. G06N 3/04; G06N 3/08

(52) U.S. Cl. CPC G06N 3/04; G06N 3/08

(57) ABSTRACT

The present disclosure relates to methods and systems for providing a neural graphical model. The methods and systems generate a neural view of the neural graphical model for a domain. The input data is generated from the domain and includes generic input data. The input data also includes a combination of different data types of input data. The neural view of the neural graphical model represents the functions of the different features of the domain using a neural network. The functions are learned for the features of the domain using a dependency structure of an input graph for the input data and the neural network. The methods and systems use the neural graphical model to perform inference tasks. The methods and systems also use the neural graphical model to perform sampling tasks.

### BACKGROUND

Graphs are ubiquitous and are often used to understand the dynamics of a system. Probabilistic Graphical Models (Bayesian and Markov networks), Structural Equation Models and Conditional Independence Graphs are some of the popular graph representation techniques that can model relationship between features (nodes) as a graph together with its underlying distribution or functions over the edges that capture dependence between the corresponding nodes. Often simplifying assumptions are made in probabilistic graphical models due to technical limitations associated with the different graph representations.

### BRIEF SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Some implementations relate to a method. The method includes receiving input data generated from a domain, wherein the input data includes a combination of different data types of the input data. The method includes identifying a dependency structure for the input data. The method includes generating a neural view of a neural graphical model for the domain using the dependency structure.

Some implementations relate to a device. The device includes a processor; memory in electronic communication with the processor; and instructions stored in the memory, the instructions executable by the processor to: receive input data generated from a domain, wherein the input data includes a combination of different data types of the input data; identify a dependency structure for the input data; and generate a neural view of a neural graphical model for the domain using the dependency structure.

Some implementations relate to a method. The method involves training a neural graphical model. The method includes learning functions for the features of the domain. The method includes initializing weights and parameters of the neural network for a neural view. The method includes optimizing the weights and the parameters of the neural network using a loss function. The method includes learning the functions using the weights and the parameters of the neural network based on paths of the features through hidden layers of the neural network from an input layer to an output layer.

Some implementations relate to a device. The device includes a processor; memory in electronic communication with the processor; and instructions stored in the memory, the instructions executable by the processor to: train a neural graphical model; learn functions for the features of the domain; initialize weights and parameters of the neural network for a neural view; optimize the weights and the parameters of the neural network using a loss function; and learn the functions using the weights and the parameters of the neural network based on paths of the features through hidden layers of the neural network from an input layer to an output layer.

Some implementations relate to a method. The method includes receiving a query for a domain. The method includes accessing a neural view of a neural graphical model trained on input data, wherein the input data includes a combination of different data types of the input data. The method includes using the neural graphical model to perform an inference task to provide an answer to the query. The method includes outputting a set of values for the neural graphical model based on the inference task for the answer.

Some implementations relate to a device. The device includes a processor; memory in electronic communication with the processor; and instructions stored in the memory, the instructions executable by the processor to: receive a query for a domain; access a neural view of a neural graphical model trained on input data, wherein the input data includes a combination of different data types of the input data; use the neural graphical model to perform an inference task to provide an answer to the query; and output a set of values for the neural graphical model based on the inference task for the answer.

Some implementations relate to a method. The method includes accessing a neural view of a neural graphical model trained on input data for a domain, wherein the input data includes a combination of different data types of the input data. The method includes using the neural graphical model to perform a sampling task. The method includes outputting a set of data samples generated by the neural graphical model based on the sampling task.

Some implementations relate to a device. The device includes a processor; memory in electronic communication with the processor; and instructions stored in the memory, the instructions executable by the processor to: access a neural view of a neural graphical model trained on input data for a domain, wherein the input data includes a combination of different data types of the input data; use the neural graphical model to perform a sampling task; and output a set of data samples generated by the neural graphical model based on the sampling task.

Additional features and advantages will be set forth in the description which follows, and in part will be obvious from the description, or may be learned by the practice of the teachings herein. Features and advantages of the disclosure may be realized and obtained by means of the instruments and combinations particularly pointed out in the appended claims. Features of the present disclosure will become more fully apparent from the following description and appended claims or may be learned by the practice of the disclosure as set forth hereinafter.

### BRIEF DESCRIPTION OF THE DRAWINGS

In order to describe the manner in which the above-recited and other features of the disclosure can be obtained, a more particular description will be rendered by reference to specific implementations thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example implementations, the implementations will be described and explained with additional specificity and detail through the use of the accompanying drawings in which:

FIG. 1 illustrates an example environment for generating neural graphical models in accordance with implementations of the present disclosure.

FIG. 2 illustrates an example neural view of a neural graphical model for use with generic data types in accordance with implementations of the present disclosure.

FIG. 3 illustrates an example method for generating a neural graphical model for use with generic data types in accordance with implementations of the present disclosure.

FIG. 4 illustrates an example method for performing an inference task using a neural view of a neural graphical model in accordance with implementations of the present disclosure.

FIG. 5 illustrates an example method for performing a sampling task using a neural view of a neural graphical model in accordance with implementations of the present disclosure.

FIG. 6 illustrates components that may be included within a computer system.

### DETAILED DESCRIPTION

This disclosure generally relates to graphs. Massive and poorly understood datasets are more and more common. Few tools exist for unrestricted domain exploration of the datasets. Most machine learning tools are oriented towards prediction: the machine learning tools select an outcome variable and input variables and only learn the impact of the latter on the former. Relationships between other variables in the dataset are ignored. Exploration can uncover data flaws and gaps that should be remedied before prediction tools can be useful. Exploration can also guide additional data collection. Graphs are an important tool to understand massive data in a compressed manner.

Moreover, graphical models are a powerful tool to analyze data. Graphical models can represent the relationship between the features of the data and provide underlying distributions that model the functional dependencies between the features of the data. Probabilistic graphical models (PGMs) are quite popular and often used to describe various systems from different domains. Bayesian networks (directed acyclic graphs) and Markov networks (undirected graphs) can represent many complex systems due to their generic mathematical formulation.

Conditional Independence (CI) graphs are a type of Probabilistic Graphical Models primarily used to gain insights about the feature correlations to help with decision making. The conditional independence graph represents the partial correlations between the features and the connections capture the features that are ‘directly’ correlated to one another. Formulations to recover such CI graphs from the input data include modeling using (1) linear regression, (2) recursive formulation, and (3) matrix inversion approaches. The CI graphs can be directed or undirected depending on the graph recovery algorithm used. However, representing the structure of the domain in the form of conditional independence graph is not sufficient.

One of the common bottleneck of traditional graphical model representations is having high computational complexities for learning, inference, and/or sampling. Learning consists of fitting the distribution function parameters. Inference is the procedure of answering queries in form of marginal distributions or reporting conditional distributions with one or more observed variables. Sampling is the ability to draw samples from the underlying distribution defined by the graphical model.

Traditional probabilistic graphical models only handle a restricted set of distributions. Traditional probabilistic graphical models place constraints on the type of distributions over the domain. An example of a constraint on a type of distribution is only allowing categorical variables. Another example of a constraint on a type of distribution is only allowing gaussian continuous variables. Another example of a constraint on a type of distribution is only dealing with continuous features. Another example is a restriction for directed graphs that there cannot be arrows pointing from continuous to categorical features. In addition, traditional probabilistic graphical models make assumptions to learn the parameters of the distribution. As such, traditional probabilistic graphical models fit a complex distribution into a restricted space, and thus, provide an approximation of a distribution over the domain.

The methods and systems of the present disclosure provide a framework for capturing a wider range of probability distributions over a domain that handles any generic input data type. The domain includes different features related to different aspects of the domain with information for each feature. One example domain is a disease process domain with different features related to the disease process. Another example domain is a college admission domain with different features relating to a student's college admission (e.g., SAT scores, high school GPA, admission to a state university, and admission to an ivy league college).

The input data may include a variety of input data types. Input data types include real input data, categorical input data, image input data, text input data, and/or an embedding representation for the input data. One example use case of a combination of different input data types includes, in the gene expression data, the input data type includes categorical meta information for the patient, gene sequence data, and images associated with the disease. The methods and systems support any combination of the input data types.

The methods and systems of the present disclosure generate a neural graphical model that represents the probabilistic distributions over the domain. The neural graphical model is a type of probabilistic graphical model that handles complex distributions over a domain and represents a richer set of distributions as compared to traditional probabilistic graphical models. The neural graphical models remove the restrictions previously placed over a domain by traditional probabilistic graphical models. For example, the neural graphical models remove the restriction placed by some traditional probabilistic graphical models that all continuous variables are gaussian. As such, the neural graphical models of the present disclosure represent complex distributions without restrictions on the domains or predefined assumptions about the domains and can capture any type of distribution defined by the data for a domain.

In some implementations, the neural graphical models are presented in a neural view with a neural network. The neural view of the neural graphical models represents the functions of the different features using a neural network. The neural network represents the distribution(s) over the domain. In some implementations, the neural network is a deep learning architecture with hidden layers. The functions represented using the neural view capture the dependencies identified in the dependency structure. The functions are represented in the neural view by the path from an input feature through the neural network layer(s) to the output feature. Thus, as the number of neural network layer increases in the neural view, the complexity of the functions represented by the neural view increases. The neural view of the neural graphical models represent complex distributions over features of a domain.

The neural graphical models may include any generic input data type or a mix of input data types. In some implementations, a projection module is added to the neural view of the neural graphical model to support generic input data types or a mix of different data types for the input data. The projection module includes one or more encoders that compresses the input data into an embedding to use with the neural view of the neural graphical model. The embedding is a vector representation of the input data. The embedding is a vector representation of high dimensional data, often low-dimensional. The projection model also includes one or more corresponding decoders that maps the embedding after passing through the neural graphical model to the input data space. For example, the decoder transforms or maps the vector representation back to the input data space.

In some implementations, the method and systems train the neural view of the neural graphical model using the input data. Any type of input data over a domain may be provided for use with the training of the neural view. In addition, any combination of data types of the input data may be provided for use with the training of the neural view. The functions of the features of a domain are learned during the training of the neural view. In some implementations, the functions are learned using a loss function that includes a regression loss from fit to the input data and a structured loss computed as a distance from a desired dependency structure.

In some implementations, the methods and systems use the neural view of the neural graphical models to learn the parameters of the functions of the features of a domain from the generic input data. By using the projection model, the input data is represented as an embedding and the methods and systems use the embeddings to learn the distributions and the parameters of the distribution using the neural graphical models. The methods and systems of the present disclosure may leverage multiple graphic processing units (GPUs) as well as scale over multiple cores, resulting in fast and efficient algorithms. As such, the neural graphical models are learned from any generic input data type, or a mix of different data types for the input data, efficiently as compared to some traditional probabilistic graphical models.

One technical advantage of the systems and methods of the present disclosure is facilitating rich representations of complex underlying distributions. Another technical advantage of the systems and methods of the present disclosure is supporting various relationship type graphs (e.g., directed, undirected, mixed-edge graphs). Another technical advantage of the systems and methods of the present disclosure is fast and efficient algorithms for learning, inference, and sampling. Another technical advantage of the systems and method of the present disclosure is handling different data types (e.g., categorical, images, text, and generic embedding representations) for the input data.

The neural graphical model of the present disclosure represents complex distributions in a compact manner, and thus, represent complex feature dependencies with reasonable computational costs. The neural graphical models capture the dependency structure between features provided by an input graph along with the features' complex function representations by using neural networks as a multi-task learning framework. The methods and systems provide efficient learning, inference, and sampling algorithms for use with the neural graphical models. The neural graphical models can use generic graph structures including directed, undirected, and mixed-edge graphs, as well as support mixed input data types. The neural graphical models can also handle different input data types (e.g., categorical data types, images, text, and generic embedding representations). The complex distributions represented by the neural graphical model may be used for downstream tasks, such as, inference, sampling, and/or prediction. As such, the neural graphical models of the present disclosure provide a framework to handle all types of variables from the input data without any restrictions on the structure or type of distributions over the domain, providing a framework to reason about every variable in the input data.

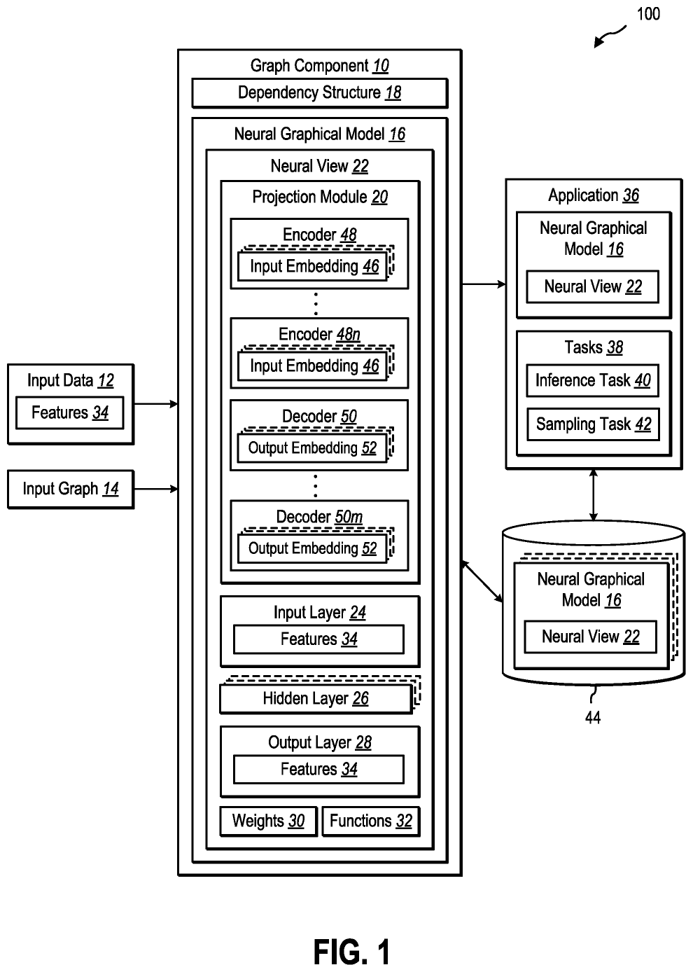

Referring now to FIG. 1, illustrated is an example environment 100 for generating neural graphical models 16. A neural graphical model 16 is a type of probabilistic graphical model implemented using a deep neural network that handles complex distributions over a domain. A domain is a complex system that is being modeled (e.g., a disease process or a school admission process). The neural graphical model 16 represents complex distributions over the domain without restrictions on the domain or predefined assumptions of the domain, and thus, may capture any type of data for the domain.

The environment 100 includes a graph component 10 that receives input data 12 for the domain. The input data 12 includes a set of samples taken from the domain with each sample containing a set of value assignments to the domain's features 34. One example domain is a college admission process and the features 34 include grades for the students, admission test scores for the students, extra circular activities for the students, and the schools that admitted the students. Another example domain is a health study relating to COVID and the features 34 include the age of the patients, the weight of the patients, pre-existing medical conditions of the patients, and whether the patients developed COVID. The input data 12 is the underlying data for an input graph 14.

In some implementations, the input data 12 consists of data samples with real numbers as feature values. In some implementations, the input data 12 consists of data samples with categorical feature values. Examples of categorical feature values include countries, colors, and/or companies. In some implementations, the input data 12 consists of data samples with medical entities as features. Examples of medical entities include diseases, drugs, and/or procedures. In some implementations, the input data 12 is tabular data. In some implementations, the input data 12 is time series data. In some implementations, the input data 12 is images. In some implementations, the input data 12 is images and caption pairs. For example, the captions describe the images or provide context for the images. In some implementations, the input data 12 is images, objects, captions tuples. For example, the objects are outlined in the images using bounding boxes and the captions describe the objects in the images or provide context for the images. In some implementations, the input data 12 is videos. In some implementations, the input data 12 is audio. In some implementations, the input data 12 are words. In some implementations, the input data 12 are sentences. In some implementations, the input data 12 is documents, webpages, and/or e-mail messages. The input data 12 may include any information about the domain. In addition, the input data 12 may be in any form.

In some implementations, the input data 12 is a combination of different data types. For example, the input data 12 is a combination of images and words. Another example includes the input data 12 is a combination of tabular data, time series data, and images. Another example includes the input data 12 is a combination of doctors' notes and images of chest x-rays. Another example includes the input data 12 is a combination of disease information, drug information, biopsy images, tabular data for patients, and time series data for patients. As such, any mix of data types for the input data 12 over a domain may be provided to the graph component 10.

The graph component 10 identifies a dependency structure 18 for the input data 12. The dependency structure 18 identifies which features 34 in the input data 12 are directly correlated to each other and which features 34 in the input data 12 exhibit conditional independencies given other features.

In some implementations, the graph component 10 uses an input graph 14 to determine a dependency structure 18 for the input graph 14. The dependency structure 18 is the set of conditional independence assumptions encoded in the input graph 14. In some implementations, the dependency structure 18 is read directly from the input graph 14. In some implementations, the dependency structure 18 is represented as an adjacency matrix for undirected graphs. In some implementations, the dependency structure 18 is represented as the list of edges for Bayesian network graphs. In some implementations, the graph component 10 receives the input graph 14 for the input data 12. The graph component 10 supports generic graph structures, including directed graphs, undirected graphs, and/or mixed-edge graphs. In some implementations, the input graph 14 is a directed graph with directed edges between the nodes of the graph. In some implementations, the input graph 14 is an undirected graph with undirected edges between nodes of the graph. In some implementations, the input graph 14 is a mixed edge type of graph with directed and undirected edges between the nodes of the graph.

In some implementations, the input graph 14 is generated by the graph component 10 using the input data 12. For example, the graph component 10 uses a graph recovery algorithm to generate the input graph 14 and determines the graph structure for the input graph 14 based on the input data 12.

The graph component 10 generates a neural graphical model 16 for the domain using the dependency structure 18. The neural graphical model 16 may use generic graph structures including directed graphs, undirected graphs, and/or mixed-edge graphs.

The graph component 10 uses the dependency structure 18 and the input data 12 to learn a neural view 22 and the weights and parameters associated with it of the neural graphical model 16. The neural view 22 includes a neural network representation of the distribution(s) over the domain. The neural view 22 includes an input layer 24 with the features 34 of the input data 12.

In some implementations, the graph component 10 adds a projection module 20 with an encoder or a set of encoders 48 (up to n, where n is a positive integer) and a decoder or a set of decoders 50 (up to m, where m is a positive integer) to the neural view 22. The projection module 20 acts as a wrapper around the neural view 22. The projection module 20 augments or expands the neural view 22. The encoder(s) 48 and/or the decoder(s) 50 may be trained independently or integrated with the neural view 22. In some implementations, the encoder(s) 48 encodes the input data 12 into one or more input embeddings 46 based on a type of the input data 12. An embedding is a vector representation of high dimensional data. The input embeddings 46 encodes different properties of the input data 12 into a compressed vector representation of the input data 12. The input embeddings 46 provide a unique representation for the input data 12. In some implementations, the decoder 50 transforms the output embeddings 52 back to a similar space as the original format or type of the input data 12. In some implementations, the encoder 48 and the decoder 50 are trained neural networks. In some implementations, the encoder 48 uses one-hot encoding and the decoder 50 uses a sigmoid function (predicting the individual one-hot entries) or softmax layer (predicting the category).

The projection module 20 allows the neural graphical model 16 to handle mixed data types of the input data 12 simultaneously by using the encoder(s) 48 to transform the input data 12 into a compressed vector representation for use with the neural graphical model 16 and the decoder 50 to transform the compressed vector representation back to the input data space.

The neural view 22 also includes hidden layers 26 of a neural network. In some implementations, the neural network is a deep learning architecture with one or more layers. The neural networks are a multi-layer perceptron with appropriate input and output dimensions depending on the graph types (directed, undirected or mixed edge) that represents the graph connections in the neural graphical model 16. The number of hidden layers 26 in the neural view 22 may vary based on the number of the features 34 of the input data 12 and the complexity of the relationship between them. As such, any number of hidden layers 26 may be used in the neural view 22.

In addition, any number of nodes in the hidden layers 26 may be used. The number of nodes of the hidden layer 26 vary based on the number of the features 34 of the input data 12. In addition, the number of nodes of the hidden layer 26 vary based on a data type of the input data 12. One example includes the number of nodes equals the number of input features 34. Another example includes the number of nodes in the hidden layers 26 equals the vector length of the input embeddings 46 output by the encoder 48. As such, as the vector size changes for the input embeddings 46, the number of nodes in the hidden layer 26 changes. The number of nodes in the hidden layers 26 may vary from one hidden layer 26 to the next hidden layer 26. Thus, the number of input features 34, the number of hidden layers 26, and/or the number of nodes in the hidden layers 26 in the neural view 22 of the neural graphical model 16 may change based on a type of the input data 12 and/or a number of the input features 34 and the complexity of relationships between features.

The neural view 22 also includes an output layer 28 with features 34. The neural view 22 also includes weights 30 applied to each connection between the nodes in the input layer 24 and the nodes in the first hidden layer 26 and the nodes in each pair of consecutive hidden layers 26 and connections between the last the hidden layer 26 and the nodes in the output layer 28. The paths from the nodes in the input layer 24 to the nodes in the output layer 28 through the nodes in the hidden layer(s) 26 represent the functional dependencies of the features 34. Different input features 34 may have different input data types, and thus, different input features 34 may have a different number of nodes in the input layer 24 corresponding to the input features 34. The number of nodes in the neural view 22 are adjusted according to the output units of the encoder 48. The paths from the nodes in the input layer 24 corresponding to the input features 34 through the hidden layer(s) 26 follow the determined path dependencies that correspond to the dependency structure 18.

One example use case includes a first input feature 34 is an image represented with an input embedding 46 with a vector length of 256. The first input feature 34 has 256 nodes of the input layer 24 corresponding to the vector length of 256 for the first input feature 34. The paths of the 256 nodes corresponding to the first input feature 34 follow the determined path dependencies in the dependency structure 18 for the first input feature 34. A second input feature 34 is a patient's age represented by a real number. The second input feature 34 has 1 node in the input layer 24 corresponding to the real number of the second input feature 34. The path of the 1 node corresponding to the second input feature 34 follows the determined path dependencies in the dependency structure 18 for the second input feature 34. A third input feature 34 is a patient's exercise history and an intensity of the patient's exercise represented by an input embedding 46 with a vector length of 4. The third input feature 34 has 4 nodes in the input layer 24 corresponding to the vector length of 4 for the third input feature 34. The paths of the 4 nodes corresponding to the third input feature 34 follow the determined path dependencies in the dependency structure 18 for the third input feature 34.

The neural view 22 also includes the functions 32 of the features 34 and/or the input embeddings 46 and the output embeddings 52 based on the paths from the nodes in the input layer 24 to the nodes in the output layer 28 through the nodes of the hidden layer(s) 26 and the weights 30 applied to each connection between the nodes in the input layer 24 and the nodes in the first hidden layer 26, the nodes in each pair of consecutive hidden layers, and connections between the last hidden layer 26 and the nodes in the output layer 28. The network parameters (e.g., the weights 30, bias terms, and activation functions at each node in the hidden layers 26 and output layers 28) jointly specify the functions 32 between the features 34. To find all paths through the network, an example equation the graph component 10 uses to perform a matrix multiplication of the weights 30 is:

Sₙₙ=Πᵢ|Wᵢ|=|W₁|×|W₂|×. . . ×|W_{C}| (1)

where W is the weights 30. If Sₙₙ[xᵢ, xₒ]=0, the output feature 34 (x₀) does not depend on the input feature 34 (xᵢ).

Increasing the number of hidden layers 26 and hidden dimensions of the neural networks, provides richer dependence function complexity for the functions 32. One example of a complex function 32 represented in the neural view 22 is an expression of the non-linear dependencies of the different features 34. A wide range of complex non-linear functions may be represented using the neural view 22. The neural view 22 of the neural graphical model 16 provides a rich functional representation of the features 34 of the input data 12 over the domain.

In some implementations, the graph component 10 performs a learning task to learn the neural view 22 of the neural graphical model 16. The learning task fits the neural networks to achieve the desired dependency structure 18, or an approximation to the desired dependency structure 18, along with fitting the regression to the input data 12. The learning task learns the functions as described by the dependency structure 18 of the neural graphical model 16. The graph component 10 solves the multiple regression problems shown in the neural view 22 by modeling the neural view 22 as a multi-task learning framework. The graph component 10 finds a set of parameters {W} (the weights 30) that minimize the loss expressed as the distance from X_{I}^{k} to ƒ_{W}(X_{I}^{k}) while maintaining the dependency structure 18 provided in the input graph 14.

One example equation the graph component 10 uses to define the regression operation is:

$${arg min}_{𝒲} {\sum }_{k = 1}^{M} {‖ {X}_{ℐ}^{k} - fw ( {X}_{ℐ}^{k} ) ‖}^{2} \\ s . t . ( {Π}_{i} \vert {W}_{i} \vert ) * {S}^{c} = 0 \qquad ( 2 )$$

where S^{c} represents the compliment of the matrix S, which replaces 0 by 1 and vice-versa. The A*B represents the hadamard operator which does an element-wise matrix multiplication between the same dimension matrices A, B, where A and B are any arbitrary matrices.

Including the constraint as a lagrangian term with [symbol] penalty and a constant λ that acts a tradeoff between fitting the regression and matching the input graph 14 dependency structure 18, in some implementations, the graph component 10 uses the following optimization formulation:

$${arg min}_{𝒲} {\sum }_{k = 1}^{M} {‖ {X}_{ℐ}^{k} - fw ( {X}_{ℐ}^{k} ) ‖}^{2} + λ {‖ ( {Π}_{i} \vert {W}_{i} \vert ) * {S}^{c} ‖}_{1} \qquad ( 3 )$$

where the bias term is not explicitly written in the optimization formulation, the graph component 10 learns the weights 30 {Wᵢ} and the biases {bᵢ} while optimizing the optimization formulation. In some implementations, the individual weights 30 are normalized using [symbol] ₂-norm before taking the product. In some implementations, the graph component 10 uses the following optimization formulation for use with generic input data 12 types:

$${arg min}_{W , proj} {\sum }_{k = 1}^{M} {‖ {X}_{ℐ}^{k} - fw ( proj ( {X}_{ℐ}^{k} ) ) ‖}^{2} + λ {‖ ( {Π}_{i} \vert {W}_{i} \vert ) * {S}^{c} ‖}_{1} \qquad ( 4 )$$

where proj is the projection module 20. Thus, in some implementations, the projection module 20 is learned by the graph component 10 using the optimization formulation. In some implementations, the projection module 20 is pretrained depending on the data type of the input data 12 and/or user preferences. In some implementations, the graph component 10 uses the following equation for choosing the value of λ:

λ=∥(Πᵢ|Wᵢ⁰|)*S^{e}∥₂² (5)

and updates after each epoch.

In some implementations, an efficient training strategy that leverages batch processing of the encoder and decoder networks is used by extending the idea of soft-thresholding the connection patterns to the encoder and decoder networks. The graph component 10 uses the following equation for learning the neural network parameters:

$${arg min}_{𝒲 , 𝒲 , 𝒲} \text{?} {\sum }_{k = 1}^{M} {‖ {X}_{ℐ}^{k} - fw ( {X}_{ℐ}^{k} ) ‖}^{2} + {λ}_{n} {‖ ( {Π}_{i} \vert {W}_{i}^{n} \vert ) * {S}_{n}^{c} ‖}_{1} + {λ}_{e} {‖ ( {Π}_{i} \vert {W}_{i}^{c} \vert ) * {S}_{e}^{c} ‖}_{1} + {λ}_{d} {‖ ( {Π}_{i} \vert {w}_{i}^{d} \vert ) * {S}_{d}^{c} ‖}_{1} \qquad ( 6 )$$

$$\text{?} \text{indicates text missing or illegible when filed}$$

where the connectivity of the input x and the input to the neural view is modeled by the [symbol] sparsity term for the encoder network's sparsity pattern Sₑ^{c}. A similar procedure is followed for the decoder network at the output.

In some implementations, the graph component 10 finds an initialization for the neural network parameters W (the weights 30) and λ by solving the regression operation without the structure constraints. Solving the regression operation without the structure constraints provides a good initial guess of the neural network weights 30 (W⁰) for the graph component 10 to use in the learning task. The graph component 10 looks at the values of undesired paths in the initial weight guess to determine how distant this initial approximation is from the structure constraints. In some implementations, the graph component 10 chooses a fixed value of λ such that it balances between the regression loss and the structure loss for the optimization.

In some implementations, the graph component 10 uses following learning algorithm to perform the learning task and learn the neural view 22 of the neural graphical model 16.

Algorithm 1: Learning Algorithm

| Function proximal-init(X,S): | | |
|---|---|---|
| \| | fw ← lnit MLP using dimensions from S | |
| \| | [symbol] ← argminw Σₖ₌₁^{M} ∥ X [symbol] ^{k} − fw(X_{O}^{b})∥² | |
| \| | (Using ‘adam’ optimizer for E₁ epochs) | |
| └ | return [symbol] | |
| Function fit-NGM(X, S, [symbol] , λ⁰): | | |
| \| | For e = 1, ... , E₂ do | |
| \| | \| [symbol] [symbol] = Σₖ₌₁^{M} ∥X [symbol] ^{k} − fw [symbol] ( [symbol] )∥² | |
| \| | \| | +λ [symbol] ∥( [symbol] \|W [symbol] \|) [symbol] S [symbol] ∥₁ |

| \| | \| [symbol] ← backprop [symbol] [symbol] to update params |
|---|---|
| \| | \| ... (optional λ update) ... |
| \| | \| λ [symbol] ← ∥( [symbol] \|W [symbol] \|) [symbol] S [symbol] ∥₂² |
| \| | └ Detach λ [symbol] from the computational graph |
| └ | return Θ, Z, λ |
| Function NGM-learning(X,S): | |
| \| | [symbol] ← proximal-init(X,S) |
| \| | λ [symbol] ← ∥( [symbol] \|W [symbol] \|) [symbol] S [symbol] ∥₂² |
| \| | fw ← fit-NGM(X, S, [symbol] , λ⁰) |
| └ | return fw |

[symbol]

indicates data missing or illegible when filed

The neural network trained using the learning algorithm represents the distributions for the neural view 22 of the neural graphical model 16. One benefit of jointly optimizing the regression and the structure loss in a in a multi-task learning framework modeled by the neural view 22 of the neural graphical model 16 includes sharing of parameters across tasks, resulting in significantly reducing the number of learning parameters. Another benefit of jointly optimizing the regression and the structure loss in a in a multi-task learning framework modeled by the neural view 22 of the neural graphical model 16 includes making the regression task more robust towards noisy and anomalous data points.

Another benefit of the neural view 22 of the neural graphical model 16 includes fully leveraging the expressive power of the neural networks to model complex non-linear dependencies. Additionally, learning all the functional dependencies jointly allows leveraging batch learning powered with GPU based scaling to get quicker runtimes. Another benefit of the neural view 22 of the neural graphical model 16 includes accessing individual dependency functions between the variables for more fine grained analysis. Another benefit of the neural view 22 of the neural graphical model 16 includes supporting mixed input data types simultaneously. Another benefit of the neural view 22 of the neural graphical model 16 includes supporting all types of the input data 12 without any restrictions on the structure or type of distributions over the domain, providing a framework to reason about every variable in the input data 12.

The graph component 10 outputs the neural graphical model 16 and/or the neural view 22. In some implementations, the graph component 10 provides the neural graphical model 16 and/or the neural view 22 for storage in a datastore 44.

In some implementations, the graph component 10 provides the neural graphical model 16 and/or the neural view 22 to one or more applications 36 that perform one or more tasks 38 on the neural graphical model 16. The applications 36 may be accessed using a computing device. For example, a user of the environment 100 may use a computing device to access the applications 36 to perform one or more tasks 38 on the neural graphical models 16. In some implementations, the applications 36 are remote from the computing device. In some implementations, the applications 36 are local to the computing device.

One example task 38 includes prediction using the neural graphical model 16. Another example task 38 includes an inference task 40 using the neural graphical model 16. Inference is the process of using the neural graphical model 16 to answer queries. For example, a user provides a query to the application 36 and the application 36 uses the graphical model 16 to perform the inference task 40 on the neural graphical model 16 and output an answer to the query. The inference task 40 may support any input data 12 type using the neural view 22 of the neural graphical model 16.

Calculation of marginal distributions and conditional distributions are key operations for the inference task 40. Since the neural graphical models 16 are discriminative models, for the prior distributions, the marginal distributions are directly calculated from the input data 12.

One example query is a conditional query. The inference task 40 is given a value of a node Xᵢ (one of feature 34) of the neural graphical model 16 and predicts the most likely values of the other nodes (features) in the neural graphical model 16. In some implementations, the application 36 uses iterative procedures to answer conditional distribution queries over the neural graphical model 16 using the inference algorithm to perform the inference task 40.

Algorithm 2: Inference Algorithm

| Function gradient-based( [symbol] , X₁): | | |
|---|---|---|
| \| | {X [symbol] , X [symbol] } ← X₁, split the data | |
| \| | X [symbol] ← fixed tensor (known) | |
| \| | X [symbol] ← learnable tensor (unknown) | |
| \| | [symbol] ← freeze weights | |
| \| | do | |
| \| | \| | X₁ ← {X [symbol] , X [symbol] } |
| \| | \| | X_{P} = [symbol] (X₁) |
| \| | \| | [symbol] [symbol] = ∥X_{P}[k] − X₁[k]∥₂² |
| \| | \| | X [symbol] ← updated by backprop on [symbol] [symbol] |
| \| | while [symbol] [symbol] > [symbol] | |
| └ | rerturn X [symbol] | |
| Function message-passing( [symbol] , X⁰): | | |
| \| | X_{K} + X_{U}⁰ ← X⁰, split the data | |
| \| | t = 0 | |
| \| | while ∥X [symbol] − X [symbol] ∥₂² > [symbol] do | |
| \| | \| | {X [symbol] ; X [symbol] } = [symbol] ({X [symbol] ; X [symbol] }) |
| \| | └ | t = t + 1 |

| └ | return X [symbol] | |
|---|---|---|
| Function NGM-inference( [symbol] , X⁰): | | |
| \| | Input: [symbol] trained NGM model | |
| \| | X⁰ ∈ [symbol] ^{D×1} (mean values for unknown) | |
| \| | X ←message-passing( [symbol] , X⁰) | |
| \| | | ... or... |

| | |
|---|---|
| \| | X ←gradient-based( [symbol] , X⁰) |
| └ | return X |

[symbol]

indicates data missing or illegible when filed

The application 36 splits the features (X) into two parts Xₖ+X_{U}←X, where k denotes the variables with known (observed) values and u denotes the (target) variables with unknown values. The inference task 40 is to predict the values and/or distributions of the unknown nodes based on the trained neural graphical model 16 distributions.

In some implementations, the application 36 uses the message passing algorithm, as illustrated in the inference algorithm, for the neural graphical model 16 in performing the inference task 40. The message passing algorithm keeps the observed values of the features fixed and iteratively updates the values of the unknowns until convergence. The convergence is defined as the distance (dependent on data type) between current feature prediction and the value in the previous iteration of the message passing algorithm. The values are updated by passing the newly predicted feature values through the neural view 22 of the neural graphical model 16.

In some implementations, the application 36 uses the gradient-based algorithm, as illustrated in the inference algorithm, for the neural graphical model 16 in performing the inference task 40. The weights 30 of the neural view 22 of the trained neural graphical model 16 are frozen once trained. The features (X) are divided into fixed Xₖ (observed) and learnable Xᵤ (target) tensors. A regression loss is defined over the known attribute values to ensure that the prediction matches values for the observed features. Using the regression loss, the learnable input tensors are updated until convergence to obtain the values of the target features.

Since the neural view 22 of the neural graphical model 16 is trained to match the output layer 28 to the input layer 24, the procedure of iteratively updating the unknown features such that the input and output matches. The regression loss is grounded based on the observed feature values. Based on the convergence loss value reached after the optimization, the confidence in the inference task 40 may be assessed. Furthermore, plotting the individual feature dependency functions also help in gaining insights about the predicted values. The neural view 22 also allows the inference task 40 to move forward or backwards through the neural network to provide an answer to the query.

Another example task 38 includes a sampling task 42 using the neural graphical model 16. Sampling is the process to get sample data points from the neural graphical model 16. One example use case of sampling includes accessing a trained neural view 22 for a neural graphical model 16 for patients with COVID. The sampling task 42 generates new patients jointly matching the distribution of the original input data. The sampling task 42 may support any input data 12 type using the neural view 22 of the neural graphical model 16.

In some implementations, a user uses a computing device to access the application 36 to perform the sampling task 42 using the neural graphical model 16. In some implementations, the application 36 uses a sampling algorithm to perform the sampling task 42 over the neural graphical model 16.

Algorithm 3: Sampling Algorithm
Algorithm 3: NGMs: Sampling algorithm

| Function get-sample( [symbol] , [symbol] [symbol] ): | | |
|---|---|---|
| \| | D = len( [symbol] [symbol] ) | |
| \| | X ∈ [symbol] ^{D×1} (random init, learnable tensor) | |
| \| | For i = 1, ... , D do | |
| \| | \| | X[i] = X[i] + [symbol] (add random noise) |
| \| | \| | X [symbol] ← X[1 : i] (fixed tensor) |
| \| | \| | X [symbol] ← X[i + 1 : D] (learnable tensor) |
| \| | \| | X ← {X [symbol] , X [symbol] } |
| \| | └ | X ← NGM-inference( [symbol] , X) |

| └ | return X |
|---|---|
| Function NGM-sampling( [symbol] , G): | |
| \| | Input: [symbol] learned NGM model |
| \| | Randomly choose xᵢ’th feature |
| \| | [symbol] [symbol] =BFS(G,x [symbol] ) [undirected] |
| \| | ... queue the features ... |
| \| | [symbol] [symbol] =topological-son(G) [DAGs] |
| \| | X ←get-sample( [symbol] , [symbol] [symbol] ) |
| └ | return X |

[symbol]

indicates data missing or illegible when filed

The sampling task 42 for the neural graphical models 16 based on undirected input graphs 14 uses the following equation:

Xᵢ=ƒₙₙ(nbrs(Xᵢ))+∈ (7)

where ∈˜P is random noise. The sampling task 42 for the neural graphical models 16 based on directed input graphs 14 uses the equation (8) with MB(Xᵢ) instead of nbrs(Xᵢ) where MB denotes the Markov blanket of a node in a directed acyclic graph.

The sampling task 42 starts by choosing a feature at random in the neural graphical model 16 and based on the dependency structure 18 of the neural graphical model 16. In some implementations, the input graph 14 that the neural graphical model 16 is based on is an undirected graph and a breadth-first-search is performed to get the order in which the features will be sampled and the nodes are arranged in Dₛ. In some implementations, the input graph 14 that the neural graphical model 16 is based on is a directed graph and a topological sort is performed to get the order in which the features will be sampled, and the nodes are arranged in Dₛ. In this way, the immediate neighbors are chosen first and then the sampling spreads over the neural graphical model 16 away from the starting feature. As the sampling procedure goes through the ordered features, a slight random noise is added to the corresponding feature while keeping the noise fixed for the subsequent iterations (feature is now observed).

The sampling task 42 calls the inference algorithm conditioned on these fixed features to get the value of the next feature. The process is repeated until a sample value of all the features is obtained. The new sample of the neural graphical model 16 is not derived from the previous sample, avoiding the ‘burn-in’ period issue with traditional sampling tasks (e.g., Gibbs sampling) where initial set of samples are ignored. The conditional updates for the neural graphical models 16 are of the form p(Xᵢ^{k}, Xᵢ₊₁^{k}, . . . ,X_{D}^{k}|Xᵢ^{k}, . . . ,Xᵢ₋₁^{k}). The sampling task 42 fixes the value of features (with a small added noise) and run inference on the remaining features until obtaining the values of all the features, and thus, obtain a new sample. The inference algorithm of the neural graphical model 16 facilitates conditional inference on multiple unknown features over multiple observed features. By leveraging the inference algorithm of the neural graphical model 16, faster sampling from the neural graphical model 16 is achieved.

In some implementations, one or more computing devices (e.g., servers and/or devices) are used to perform the processing of the environment 100. The one or more computing devices may include, but are not limited to, server devices, personal computers, a mobile device, such as, a mobile telephone, a smartphone, a PDA, a tablet, or a laptop, and/or a non-mobile device. The features and functionalities discussed herein in connection with the various systems may be implemented on one computing device or across multiple computing devices. For example, the graph component 10 and the application 36 are implemented wholly on the same computing device. Another example includes one or more subcomponents of the graph component 10 and/or the application 36 are implemented across multiple computing devices. Moreover, in some implementations, one or more subcomponent of the graph component 10 and/or the application 36 may be implemented are processed on different server devices of the same or different cloud computing networks.

In some implementations, each of the components of the environment 100 is in communication with each other using any suitable communication technologies. In addition, while the components of the environment 100 are shown to be separate, any of the components or subcomponents may be combined into fewer components, such as into a single component, or divided into more components as may serve a particular implementation. In some implementations, the components of the environment 100 include hardware, software, or both. For example, the components of the environment 100 may include one or more instructions stored on a computer-readable storage medium and executable by processors of one or more computing devices. When executed by the one or more processors, the computer-executable instructions of one or more computing devices can perform one or more methods described herein. In some implementations, the components of the environment 100 include hardware, such as a special purpose processing device to perform a certain function or group of functions. In some implementations, the components of the environment 100 include a combination of computer-executable instructions and hardware.

The environment 100 is used to generate neural graphical models 16 that represent complex feature dependencies with reasonable computational costs. The neural graphical models 16 capture the dependency structure 18 between the features 34 of the input data 12 along with the complex function representations by using neural networks as a multi-task learning framework. The neural graphical models 16 may handle generic input data types for the input data 12 and/or a combination of different data types for the input data 12. The environment 100 provides efficient learning, inference, and sampling algorithms for use with the neural graphical models 16. In addition, the environment 100 uses the complex distributions represented by the neural graphical models 16 for downstream tasks, such as, an inference task 40, a sampling task 42, and/or a prediction task.

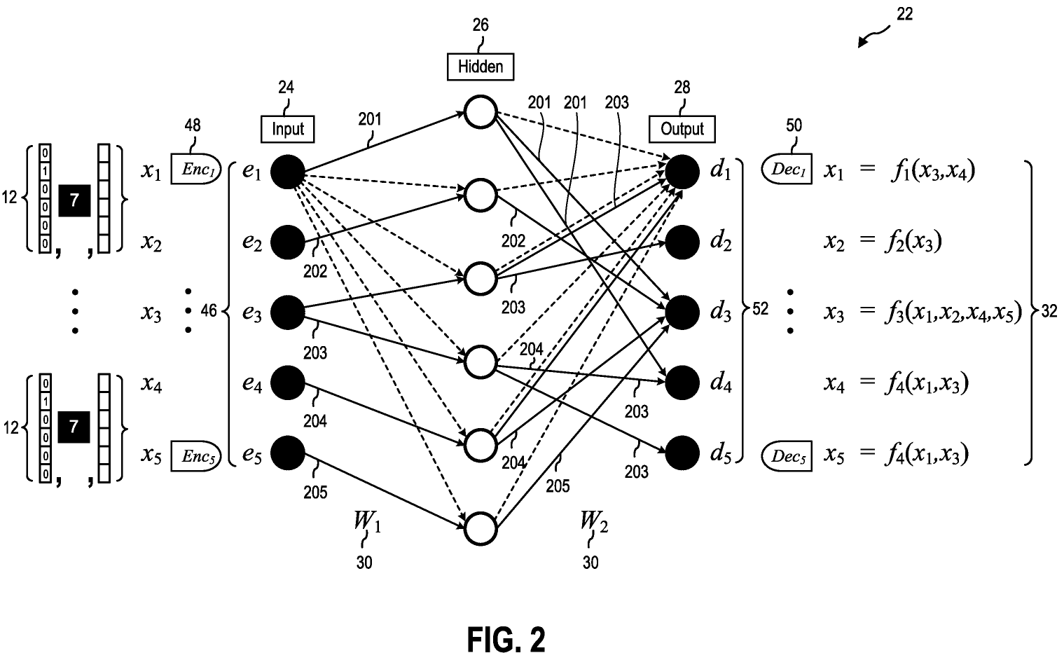

Referring now to FIG. 2, illustrated is an example neural view 22 of the neural graphical model 16 for use with generic data types. The graph component 10 (FIG. 1) generates the neural view 22 and adds the projection module 20 (FIG. 1) to the neural view 22. The projection module 20 includes a plurality of encoders 48 (Enc₁, Enc₂, Enc₃, Enc₄, Enc₅) and a plurality of decoders 50 (Dec₁, Dec₂, Dec₃, Dec₄, Dec₅).

The neural view 22 includes an input layer 24 with a plurality of features (features (xᵢ, x₂, x₃, x₄, x₅)). The plurality of features (x₁, x₂, x₃, x₄, x₅) correspond to the input data 12 that includes a combination of different data types (e.g., mixed data types). For example, the input data 12 includes an image of a number, a vector of values, and a column of tabular data. The plurality of encoders 48 (Enc₁, Enc₂, Enc₃, Enc₄, Enc₅) encode the input data 12 into one or more input embeddings 46 (e₁, e₂, e₃, e₄, e₅) based on a type of the input data 12. An embedding is a (typically low-dimensional) vector representation of high dimensional data that encodes different properties of the input data 12 into the vector representation of the input data 12.

In some implementations, each feature may correspond to a different encoder 48 based on a data type of the input data 12 associated with the feature. For example, a first feature (x₁) corresponds to a first encoder 48 (Enc₁) that generates a first input embedding 46 (e₁) for the first feature (x₁). A second feature (x₂) corresponds to a second encoder 48 (Enc₂) that generates a second input embedding 46 (e₂) for the second feature (x₂). A third feature (x₃) corresponds to a third encoder 48 (Enc₃) that generates a third input embedding 46 (e₃) for the third feature (x₃). A fourth feature (x₄) corresponds to a fourth encoder 48 (Enc₁) that generates a fourth input embedding 46 (e₄) for the fourth feature (x₄). A fifth feature (x₅) corresponds to a fifth encoder 48 (Enc₅) that generates a fifth input embedding 46 (e₅) for the fifth feature (x₅).

In some implementations, the features may correspond to a same encoder 48 based on a type of the input data 12. For example, if the first feature (x₁) and the second feature (x₂) are both images, the first feature (x₁) and the second feature (x₂) may correspond to the same encoder 48. However, each image will produce its own embedding(e.g., e₁ and e₂).

In some implementations, the output of the encoder 48 is more than 1 unit (e₁ can be a hypernode). The graph dependency structure 18 is updated to account for the additional nodes and the corresponding feature connections between the nodes and the output layer 28.

The neural view 22 also includes hidden layers 26 of the neural network. The neural view 22 also includes an output layer 28 with a plurality of output embeddings 52 (d₁, d₂, d₃, d₄, d₅) after being processed by the neural network. The neural view 22 also includes a plurality of weights 30 (W₁ and W₂) calculated and applied to the input embeddings 46 (e₁, e₂, e₃, e₄, e₅) as the input embeddings 46 are input into the first hidden layer 26 of the neural network. The output layer consists of hypernodes corresponding to output embeddings 52 (d₁, d₂, d₃, d₄, d₅) of the neural network.

The neural view 22 also includes a plurality of decoders 50. The decoders 50 transforms the output embeddings 52 (d₁, d₂, d₃, d₄, d₅) after being processed by the neural network back to a similar space as the original format or type of the input data 12.

For example, a first output embedding 52 (d₁) corresponds to a first decoder 50 (Dec₁) that transforms the first output embedding 52 (d₁) back to a similar space as the first feature (x₁). A second output embedding 52 (d₂) corresponds to a second decoder 50 (Dec₂) that transforms the second output embedding 52 (d₂) back to a similar space as the second feature (x₂). A third output embedding 52 (d₃) corresponds to a third decoder 50 (Dec₃) that transforms the third output embedding 52 (d₃) back to a similar space as the third feature (x₃). A fourth output embedding 52 (d₄) corresponds to a fourth decoder 50 (Dec₄) that transforms the fourth output embedding 52 (d₄) back to a similar space as the fourth feature (x₄). A fifth output embedding 52 (d₅) corresponds to a fifth decoder 50 (Dec₅) that transforms the fifth output embedding 52 (d₅) back to a similar space as the fifth feature (x₅).

In the neural view 22, a path from the input feature to an output feature indicates a dependency between the input feature and the output feature. The dependency matrix between the input and output of the neural network reduces to a matrix multiplication operation Snn=Πi|Wi|=|W1|×|W2|, which represents the product of the neural network weights that are normalized. For directed graphs, the directed graphs are first converted to an undirected graph by following a process called moralization. Moralizing the directed graphs facilitates downstream analysis of the directed graphs. After obtaining the moral graph, the dependency structure 18 may be modeled in the neural view 22 using a multi-layer perceptron that maps all features from the input layer 24 to the output layer 28.

The neural view 22 also includes the associated functions 32 (f₁, f₂, f₃, f₄, f₅) for the features (x₁, x₂, x₃, x₄, x₅) computed using the entire neural network of the neural view 22. By applying the network parameters (e.g., the weights 30, bias terms, and activation functions at each node in the hidden layers 26 and output layers 28) to the input embeddings 46 (e₁, e₂, e₃, e₄, e₅), the functions 32 are generated based on the entire path through the neural network from the input layer 24 to the output layer 28 containing output embeddings 52 (d₁, d₂, d₃, d₄, d₅) after being processed by the neural network are more complex and expressive. Thus, by adding layers to the hidden layers 26 and increasing the weights 30, the expressiveness and complexity of the functions 32 generated increases.

In some implementations, the input data 12 includes categorical variables as input. For example, the input data 12 (X), has a column X_{c} having |C| different categorical entries. In some implementations, the encoder 48 performs one-hot encoding on the column X_{c} for the categorical input and ends up with |C| different columns, X_{c}=[X_{c1}, X_{c2}, . . . , X_{cC}]. The encoder 48 replaces the single categorical column with the corresponding one-hot representation in the original data as the input embedding 46. The neural view 22 maintains the data dependency structure 18 such that whatever connections where previously connected to the categorical column X_{c} should be maintained for all the one-hot columns as well. Thus, the one-hot columns are connected in the neural view 22 to represent the same path connections as the original categorical column. If the projection modules 20 are used (e.g., the encoders 48 and the decoders 50), the number of nodes in the neural view input are adjusted according to the output units of the encoder. In the output, a sigmoid function (predicting individual one-hot entries) or a softmax layer (predicting the category) based on how one defines the regression loss function may be used optionally. Appropriate dimensions are adjusted to account for the decoder 50 module, if added.

The paths 201 through the hidden layer 26 of the neural network illustrate the connections of the feature (x₁) to the feature (x₃) and the feature (x₄). The path 202 through the hidden layer 26 of the neural network illustrates the connection of the feature (x₂) to the feature (x₃). The paths 204 through the hidden layer 26 of the neural network illustrate the connections of the feature (x₃) to the features (x₁), (x₂), (x₄), and (x₅). The paths 204 through the hidden layer 26 of the neural network illustrate the connections of the feature (x₄) to the feature (x₁) and the feature (x₃). The path 205 through the hidden layer 26 of the neural network illustrates the connection of the feature (x₅) to the feature (x₃). The functions 32 (f₁, f₂, f₃, f₄, f₅) illustrated are based on the paths 201, 202, 203, and 204 through the neural networks. The functions 32 (f₁, f₂, f₃, f₄, f₅) provided by the neural view 22 provide a rich functional representation of the dependencies of the features (x₁, x₂, x₃, x₄, x₅).

As such, the neural view 22 facilitates rich representations of complex underlying distributions of the domain. While only one hidden layer 26 is shown in FIG. 2, any number of hidden layers 26 and/or any number of nodes in each hidden layer 26 may be added to the neural view 22. By adding the projection module 20 to the neural view 22, any generic data type for the input data 12 may be used with the neural graphical model 16 or any combination of data types for the input data 12 may be used at the same time in the neural graphical model 16.

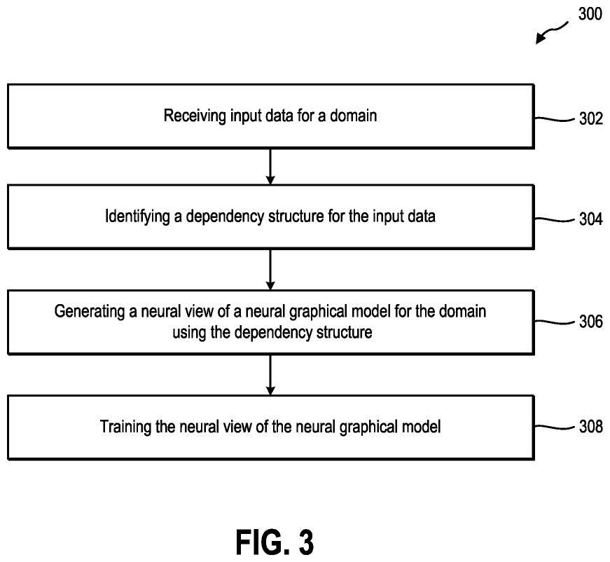

Referring now to FIG. 3, illustrated is an example method 300 for generating a neural view of a neural graphical model for use with generic data types. The actions of the method 300 are discussed below with reference to the architectures of FIGS. 1 and 2.

At 302, the method 300 includes receiving input data for a domain. The graph component 10 obtains the input data 12 for the domain. The input data 12 includes a plurality of data points for the domain with information for the features 34. In some implementations, the input data 12 consists of data points with values that are real numbers. In some implementations, the input data 12 consists of data points with categorical feature values. Examples of categorical feature values include countries, colors, and/or companies. In some implementations, the input data 12 consists of data points with features that are medical entities. Examples of medical entities include diseases, drugs, and/or procedures. In some implementations, the input data 12 is tabular data. In some implementations, the input data 12 is time series data. In some implementations, the input data 12 is images. In some implementations, the input data 12 is images and caption pairs. For example, the captions describe the images or provide context for the images. In some implementations, the input data 12 is images, objects, captions tuples. For example, the objects in the images are marked with bounding boxes and the captions describe the objects in the images or provide context for the images. In some implementations, the input data 12 is videos. In some implementations, the input data 12 is audio. In some implementations, the input data 12 are words. In some implementations, the input data 12 are sentences. In some implementations, the input data 12 is documents, webpages, and/or e-mail messages. The input data 12 may include any information about the domain. In addition, the input data 12 may be in any form.

In some implementations, the input data 12 is a combination of different data types of the input data 12. For example, the input data 12 is a combination of images and words. Another example includes the input data 12 is a combination of tabular data, time series data, and images. Another example includes the input data 12 is a combination of disease information, drug information, biopsy images, tabular data for patients, and time series data for patients. As such, any mix of input data 12 over a domain may be provided to the graph component 10.

At 304, the method 300 includes identifying a dependency structure for the input data. The graph component 10 identifies the dependency structure 18 for the input data 12. In some implementations, the graph component 10 uses an input graph 14 of the input data 12 to determine a dependency structure 18 for the input graph 14. The graph component 10 supports generic graph structures, including directed graphs, undirected graphs, and/or mixed-edge graphs. The dependency structure 18 identifies features 34 in the input data 12 that are directly correlated to one another and the features 34 in the input data 12 that are conditionally independent from one another.

At 306, the method 300 includes generating a neural view of a neural graphical model for the domain using the dependency structure. The neural graphical model 16 is a probabilistic graphical model, and the functions 32 represent complex distributions over the domain. The neural graphical model 16 uses a directed input graph 14, an undirected input graph 14, or a mixed-edge input graph 14. The graph component 10 generates the neural view 22 of the neural graphical model 16 for the domain using the dependency structure 18.

In some implementations, the graph component 10 provides a neural view 22 of the neural graphical model 16. The neural view 22 includes an input layer 24 with features 34 of the input data 12, an encoder that compresses the input data 12 to input embeddings 46, a neural network with multiple hidden layers 26 (e.g., a multilayer perceptron), weights 30 applied to each connection between the nodes in the input layer 24, the nodes in the first hidden layer 26, the nodes in each pair of consecutive hidden layers 26, and nodes between the last hidden layer 26 and the nodes in an output layer 28, bias terms and activation functions, the output layer 28 with the output embeddings 52, and a decoder that transforms the output embeddings 52 at the output layer 28 to the input data space. A complexity of the functions 32 is based on paths of the input embeddings 46 and the output embeddings 52 or features 34 through the hidden layers 26 of the neural network from the input layer 24 to the output layer 28 and the different weights 30 and activation functions at the nodes of the neural network. The input embeddings 46 are compressed vector representations of the input data 12. In some implementations, the input embeddings 46 encode different properties of the input data 12 as a vector of numbers.

At 308, the method 300 includes training the neural view of the neural graphical model. The graph component 10 trains the neural view 22 of the neural graphical model 16 using the input data 12. Any type of input data 12 over a domain may be provided to the graph component 10 for use with the training of the neural view 22 of the neural graphical model 16. In addition, any combination of different data types of the input data 12 may be provided to the graph component 10 for use with the training of the neural view 22 of the neural graphical model 16. The graph component 10 learns the functions 32 for the features 34 the domain during the training of the neural view 22 of the neural graphical model 16. The functions 32 are learned during the training of the neural view 22 using a loss function comprising regression loss from fit to the input data 12 and structure loss computed as a distance from the desired dependency structure 18.

In some implementations, the graph component 10 performs a learning task to learn the functions 32 of the neural view 22 using the input data 12. In some implementations, the graph component 10 uses a learning algorithm (Algorithm 1: Learning Algorithm) to perform the learning task and learn the neural view 22 of the neural graphical model 16. The graph component 10 initializes the weights 30 and the parameters of the neural network for the neural view 22. The graph component 10 optimizes the weights 30 and the parameters of the neural network using a loss function. The loss function fits the neural network to the dependency structure 18 along with fitting a regression of the input data 12. In some implementations, the number of nodes in the hidden layers 26 of the neural network are based on output units of the encoder 48. For example, the number of nodes in the neural network equals a vector length of the input embedding 46 output by the encoder 48 for the input data 12. One example use case includes a first input data type of an image. The encoder 48 outputs an embedding with a vector length of 256 for the image. Thus, the number of input nodes in the neural network for the image equals 256. A second input data type includes a categorical value. The encoder 48 outputs an embedding with a vector length of 10 for the categorical value and the number of input nodes in the neural network for the categorical value equals 10. As such, a different number of nodes in the input layer may be assigned to different input data types. The graph dependency structure 18 is updated to account for the additional nodes and the corresponding feature connections between the nodes in all network layers.

The graph component 10 learns the functions 32 using the weights 30 and the parameters of the neural network and updates the paths of the input embeddings 46 and/or the features 34 through the hidden layers 26 of the neural network from the input layer 24 to the output layer 28 based on the functions 32 learned. As such, the graph component 10 models the neural view 22 as a multi-task learning framework that finds a set of parameters that minimize the loss while maintaining the dependency structure 18 provided in the input graph 14.

In some implementations, the graph component 10 provides the neural view 22 of the neural graphical model 16 as output on a display of a computing device. In some implementations, the graph component 10 provides the neural view 22 of the neural graphical model 16 for storage in a datastore 44.

The method 300 is used to learn complex functions 32 of any generic input data 12 and/or any combination of different data types of the input data 12. The neural view 22 facilitates rich representations of complex underlying distributions in the input data 12 using neural networks. Different sources or applications may use the representation of the neural view 22 to perform various tasks.

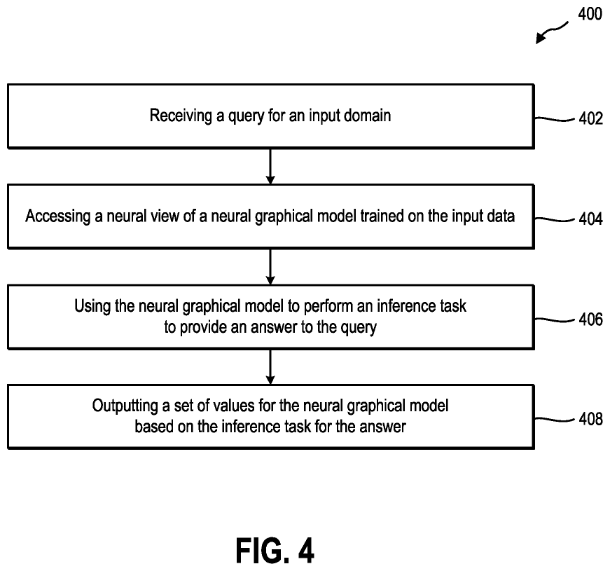

Referring now to FIG. 4, illustrated is an example method 400 for performing an inference task using a neural view of a neural graphical model. The actions of the method 400 are discussed below with reference to the architectures of FIGS. 1 and 2.

At 402, the method 400 includes receiving a query for an input domain. A user, or other application, provides a query to the application 36 for an input domain. One example query is a conditional distribution query.

At 404, the method 400 includes accessing a neural view of a neural graphical model trained on the input data. The application 36 accesses a trained neural graphical model 16 of the domain associated with the query. In some implementations, the input data 12 includes a combination of different data types of the input data 12. The different data types of the input data 12 includes a real number value, a categorical feature value, text input, a medical entity, tabular data, time series data, an image, a caption, an object, a video, audio data, words, phrases, sentences, a document, a webpage, or an e-mail message.

The trained neural graphical model 16 provides insights into the domain from which the input data 12 was generated and which variables within the domain are correlated. The neural view 22 includes an input layer 24 with features 34 of the input data 12, an encoder that compresses the input data to input embeddings 46, a neural network with multiple hidden layers 26 (e.g., a multilayer perceptron), weights 30 between the input layer 24 and the first hidden layer 26 and the last hidden layer 26 and an output layer 28, the output layer 28 with the output embeddings 52, and a decoder that transforms the output embeddings 52 at the output layer 28 to the input data space. In some implementations, the graph component 10 provides the neural graphical model 16 and/or the neural view 22 to the application 36. In some implementations, the application 36 accesses the neural graphical model 16 from a datastore 44.

At 406, the method 400 includes using the neural graphical model to perform an inference task to provide an answer to the query. The application 36 uses the neural graphical model 16 to perform an inference task 40 to answer queries. The inference task 40 splits the features 34 (X) into two parts Xₖ+X_{U}←X, where k denotes the variables with known (observed) values and u denotes the unknown (target) variables. The inference task 40 is to predict the values of the unknown nodes based on the trained neural graphical model 16 distributions. The inference task 40 accepts a value of one or more nodes (features 34) of the neural graphical model 16 and predicts the most likely values of the other nodes in the neural graphical model 16. The neural view 22 also allows the inference task 40 to move forward or backwards through the neural network to provide an answer to the query. In some implementations, the application 36 uses iterative procedures to answer conditional distribution queries over the neural graphical model 16 using the inference algorithm (Algorithm 2: Inference Algorithm) to perform the inference task 40.

In some implementations, the inference task 40 uses the message passing algorithm, as illustrated in the inference algorithm (Algorithm 2: Inference Algorithm), for the neural graphical model 16 in performing the inference task 40. The message passing algorithm keeps the observed values of the features fixed and iteratively updates the values of the unknowns until convergence. The convergence is defined as the distance (dependent on data type) between current feature prediction and the value in the previous iteration of the message passing algorithm. The values are updated by passing the newly predicted feature values through the neural view 22 of the neural graphical model 16.

In some implementations, the inference task 40 uses the gradient-based algorithm, as illustrated in the inference algorithm (Algorithm 2: Inference Algorithm), for the neural graphical model 16 in performing the inference task 40. The weights 30 of the neural view 22 of the trained neural graphical model 16 are frozen once trained. The set of features 34 (X) is divided into fixed Xₖ (observed) and learnable Xᵤ (target) tensors. A regression loss is defined over the known attribute values to ensure that the prediction matches values for the observed features. Using the regression loss, the learnable input tensors are updated until convergence to obtain the values of the target features.

At 408, the method 400 includes outputting a set of values for the neural graphical model based on the inference task for the answer. The application 36 outputs the set of values for the neural graphical model 16 based on the inference task 40 for the answer to the query. In some implementations, the set of values are a set of fixed values, one for each target variable. In some implementations, the set of values is a set of distributions over values of target variables. In some implementations, the set of values is both a set of fixed values and a set of distributions over values.

The neural graphical model 16 provides direct access to the learned underlying distributions over the features 34 for analysis in the inference task 40. As such, the method 400 uses the neural graphical model 16 to perform fast and efficient inference tasks 40 for any generic input data type. In addition, the method 400 uses the neural graphical model 16 to perform fast and efficient inference tasks 40 on mixed input data types. Thus, the method 400 allows the inference tasks 40 to occur on different data types of the input data 12 at the same time.

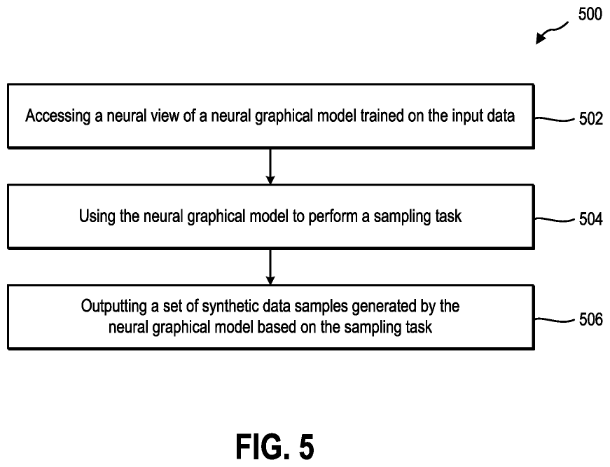

Referring now to FIG. 5, illustrated is an example method 500 for performing a sampling task using a neural view of a neural graphical model. The actions of the method 500 are discussed below with reference to the architectures of FIGS. 1 and 2.

At 502, the method 500 includes accessing a neural view of a neural graphical model trained on the input data. The application 36 accesses a neural view 22 of a trained neural graphical model 16 of the domain. In some implementations, the input data 12 includes a combination of different data types of the input data 12. The different data types of the input data 12 include a real number value, a categorical feature value, text input, a medical entity, tabular data, time series data, an image, a caption, an object, a video, audio data, words, phrases, sentences, a document, a webpage, or an e-mail message.

The trained neural graphical model 16 provides insights into the domain and which variables within the domain are correlated. In some implementations, the graph component 10 provides the neural graphical model 16 and/or the neural view 22 to the application 36. The neural view 22 includes an input layer 24 with features 34 of the input data 12, an encoder that compresses the input data to an input embedding 46, a neural network with multiple layers (e.g., a multilayer perceptron), weights 30 between the input layer 24 and the first hidden layer 26 and the last hidden layer 26 and an output layer 28, the output layer 28 with the output embeddings 52, and a decoder that transforms the output embeddings 52 at the output layer 28 to the input data space. In some implementations, the application 36 accesses the neural graphical model 16 from a datastore 44.

At 506, the method 500 includes using the neural graphical model to perform a sampling task. In some implementations, a user uses a computing device to access the application 36 to perform the sampling task 42 using the neural graphical model 16. In some implementations, the application 36 uses a sampling algorithm (Algorithm 3: Sampling Algorithm) to perform the sampling task 42 over the neural graphical model 16. Sampling is the process to get sample points from the neural graphical model 16.

The sampling task 42 starts by choosing a feature at random in the neural graphical model 16 and based on the dependency structure 18 of the neural graphical model 16. In some implementations, the input graph 14 that the neural graphical model 16 is based on is an undirected graph and a breadth-first-search is performed to get the order in which the features will be sampled and the nodes are arranged in Dₛ. In some implementations, the input graph 14 that the neural graphical model 16 is based on is a directed graph and a topological sort is performed to get the order in which the features will be sampled, and the nodes are arranged in Dₛ. In this way, the immediate neighbors are chosen first and then the sampling spreads over the neural graphical model 16 away from the starting feature. As the sampling procedure goes through the ordered features, a random noise is added to the corresponding feature value while keeping the value fixed for the subsequent iterations (feature is now observed).

The sampling task 42 calls the inference algorithm conditioned on these fixed features to get the values of the next unknown feature. The process is repeated until a sample value of all the features is obtained. The new sample of the neural graphical model 16 is not derived from the previous sample, avoiding the ‘burn-in’ period issue with traditional sampling tasks (e.g., Gibbs sampling) where initial set of samples are ignored. The conditional updates for the neural graphical models 16 are of the form p(Xᵢ^{k}, Xᵢ₊₁^{k}, . . . , X_{D}^{k}|X₁^{k}, . . . , Xᵢ₋₁^{k}). The sampling task 42 fixes the value of features (with a small added noise) and run inference on the remaining features until obtaining the values of all the features, and thus, obtain a new sample. The inference algorithm of the neural graphical model 16 facilitates conditional inference on multiple unknown features over multiple observed features. By leveraging the inference algorithm of the neural graphical model 16, faster sampling from the neural graphical model 16 is achieved.

As such, the sampling task 42 randomly selects a node in the neural graphical model 16 as a starting node, places the remaining nodes in the neural graphical model in an order relative to the starting node, and creates a value for each node of the remaining nodes in the neural graphical model 16 based on values from neighboring nodes to each node of the remaining nodes. Random noise may be added to the values obtained by the sampling from a distribution conditioned on the neighboring nodes.

At 506, the method 500 includes outputting a set of synthetic data samples generated by the neural graphical model based on the sampling task. The application 36 outputs a set of synthetic data samples generated by the neural graphical model 16 based on the sampling task 42. The set of samples includes values for each feature in the features 34 in each sample generated from the neural graphical model 16.

The method 500 may be used to create values for the nodes from a same distribution over the domain from which the input data 12 was generated. In addition, the method 500 may be used to create values for the nodes from conditional distributions of the neural graphical model conditioned on a given evidence. The method 500 uses the neural graphical model 16 to perform fast and efficient sampling tasks 42 for any generic input data type. The method 500 also uses the neural graphical model 16 to perform fast and efficient sampling tasks 42 on mixed input data types. Thus, the method 500 allows the sampling tasks 42 to occur on different data types of the input data 12 at the same time.

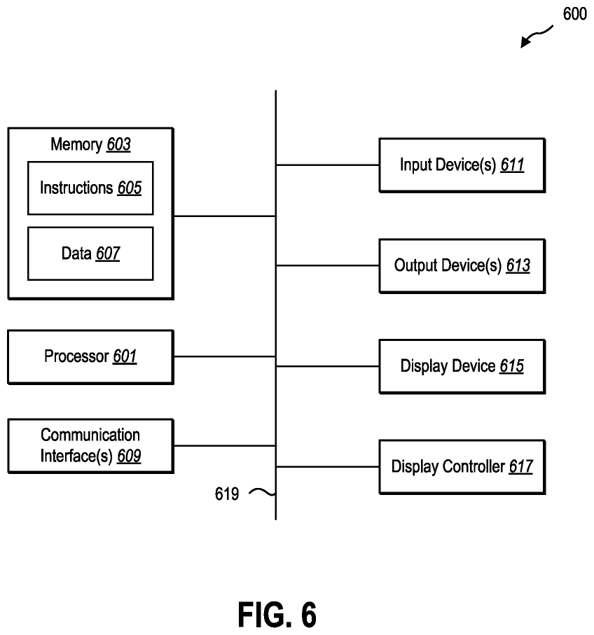

FIG. 6 illustrates components that may be included within a computer system 600. One or more computer systems 600 may be used to implement the various methods, devices, components, and/or systems described herein.

The computer system 600 includes a processor 601. The processor 601 may be a general-purpose single or multi-chip microprocessor (e.g., an Advanced RISC (Reduced Instruction Set Computer) Machine (ARM)), a special purpose microprocessor (e.g., a digital signal processor (DSP)), a microcontroller, a programmable gate array, etc. The processor 601 may be referred to as a central processing unit (CPU). Although just a single processor 601 is shown in the computer system 600 of FIG. 6, in an alternative configuration, a combination of processors (e.g., an ARM and DSP) could be used.

The computer system 600 also includes memory 603 in electronic communication with the processor 601. The memory 603 may be any electronic component capable of storing electronic information. For example, the memory 603 may be embodied as random access memory (RAM), read-only memory (ROM), magnetic disk storage mediums, optical storage mediums, flash memory devices in RAM, on-board memory included with the processor, erasable programmable read-only memory (EPROM), electrically erasable programmable read-only memory (EEPROM) memory, registers, and so forth, including combinations thereof.

Instructions 605 and data 607 may be stored in the memory 603. The instructions 605 may be executable by the processor 601 to implement some or all of the functionality disclosed herein. Executing the instructions 605 may involve the use of the data 607 that is stored in the memory 603. Any of the various examples of modules and components described herein may be implemented, partially or wholly, as instructions 605 stored in memory 603 and executed by the processor 601. Any of the various examples of data described herein may be among the data 607 that is stored in memory 603 and used during execution of the instructions 605 by the processor 601.

A computer system 600 may also include one or more communication interfaces 609 for communicating with other electronic devices. The communication interface(s) 609 may be based on wired communication technology, wireless communication technology, or both. Some examples of communication interfaces 609 include a Universal Serial Bus (USB), an Ethernet adapter, a wireless adapter that operates in accordance with an Institute of Electrical and Electronics Engineers (IEEE) 802.11 wireless communication protocol, a Bluetooth ® wireless communication adapter, and an infrared (IR) communication port.

A computer system 600 may also include one or more input devices 611 and one or more output devices 613. Some examples of input devices 611 include a keyboard, mouse, microphone, remote control device, button, joystick, trackball, touchpad, and lightpen. Some examples of output devices 613 include a speaker and a printer. One specific type of output device that is typically included in a computer system 600 is a display device 615. Display devices 615 used with embodiments disclosed herein may utilize any suitable image projection technology, such as liquid crystal display (LCD), light-emitting diode (LED), gas plasma, electroluminescence, or the like. A display controller 617 may also be provided, for converting data 607 stored in the memory 603 into text, graphics, and/or moving images (as appropriate) shown on the display device 615.

The various components of the computer system 600 may be coupled together by one or more buses, which may include a power bus, a control signal bus, a status signal bus, a data bus, etc. For the sake of clarity, the various buses are illustrated in FIG. 6 as a bus system 619.

In some implementations, the various components of the computer system 600 are implemented as one device. For example, the various components of the computer system 600 are implemented in a mobile phone or tablet. Another example includes the various components of the computer system 600 implemented in a personal computer.

As illustrated in the foregoing discussion, the present disclosure utilizes a variety of terms to describe features and advantages of the model evaluation system. Additional detail is now provided regarding the meaning of such terms. For example, as used herein, a “machine learning model” refers to a computer algorithm or model (e.g., a classification model, a clustering model, a regression model, a language model, an object detection model) that can be tuned (e.g., trained) based on training input to approximate unknown functions. For example, a machine learning model may refer to a neural network (e.g., a convolutional neural network (CNN), deep neural network (DNN), recurrent neural network (RNN)), or other machine learning algorithm or architecture that learns and approximates complex functions and generates outputs based on a plurality of inputs provided to the machine learning model. As used herein, a “machine learning system” may refer to one or multiple machine learning models that cooperatively generate one or more outputs based on corresponding inputs. For example, a machine learning system may refer to any system architecture having multiple discrete machine learning components that consider different kinds of information or inputs.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular data types, and which may be combined or distributed as desired in various implementations.

Computer-readable mediums may be any available media that can be accessed by a general purpose or special purpose computer system. Computer-readable mediums that store computer-executable instructions are non-transitory computer-readable storage media (devices). Computer-readable mediums that carry computer-executable instructions are transmission media. Thus, by way of example, and not limitation, implementations of the disclosure can comprise at least two distinctly different kinds of computer-readable mediums: non-transitory computer-readable storage media (devices) and transmission media.

As used herein, non-transitory computer-readable storage mediums (devices) may include RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database, a datastore, or another data structure), ascertaining and the like. Also, “determining” can include receiving (e.g., receiving information), accessing (e.g., accessing data in a memory) and the like. Also, “determining” can include resolving, selecting, choosing, establishing, predicting, inferring, and the like.

The articles “a,” “an,” and “the” are intended to mean that there are one or more of the elements in the preceding descriptions. The terms “comprising,” “including,” and “having” are intended to be inclusive and mean that there may be additional elements other than the listed elements. Additionally, it should be understood that references to “one implementation” or “an implementation” of the present disclosure are not intended to be interpreted as excluding the existence of additional implementations that also incorporate the recited features. For example, any element described in relation to an implementation herein may be combinable with any element of any other implementation described herein. Numbers, percentages, ratios, or other values stated herein are intended to include that value, and also other values that are “about” or “approximately” the stated value, as would be appreciated by one of ordinary skill in the art encompassed by implementations of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to implementations disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the implementations that falls within the meaning and scope of the claims is to be embraced by the claims.

The present disclosure may be embodied in other specific forms without departing from its spirit or characteristics. The described implementations are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method, comprising:
receiving input data generated from a domain, wherein the input data includes a combination of different data types of the input data;
identifying a dependency structure for the input data; and
generating a neural view of a neural graphical model for the domain using the dependency structure.

2. The method of claim 1, wherein the input data includes real number values, categorical feature values, text input, medical entities, tabular data, time series data, images, captions, objects, videos, audio data, words, phrases, sentences, documents, webpages, or e-mail messages.

3. The method of claim 1, wherein the neural graphical model is a probabilistic graphical model, and functions represent complex distributions over the domain, and the neural view of the neural graphical model further comprises:
an input layer with features of the domain;
an encoder that transforms the input data to an embedding;
a neural network with multiple layers;
weights, wherein the weights are applied to each connection between the input layer, hidden layers of the neural network, and an output layer;
bias terms and activation functions;
the output layer with the embedding; and
a decoder that transforms the embedding at the output layer to an input data space.

4. The method of claim 3, wherein the embedding is a vector representation of the input data.

5. The method of claim 3, wherein the embedding encodes different properties of the input data as a vector of numbers.

6. The method of claim 3, wherein a number of nodes in the input layer is based on output units of the encoder.

7. The method of claim 6, wherein a first input data type has a first number of nodes in the input layer and a second input data type has a second number of nodes in the input layer different from the first number of nodes.

8. The method of claim 6, further comprising:
updating the dependency structure of the neural view for the number of nodes and corresponding connections between the features.

9. The method of claim 1, wherein the dependency structure identifies features in the input data that are directly correlated to one another and the features in the input data that are conditionally independent from one another given other features.

10. The method of claim 1, further comprising:
training the neural view of the neural graphical model using a combination of different data types of the input data.

11. The method of claim 10, wherein functions for features of the domain are learned during the training of the neural view using a loss function comprising regression loss from fit to the input data and structure loss computed as a distance from a desired dependency structure.

12. A method, comprising:
receiving a query for a domain;
accessing a neural view of a neural graphical model trained on input data, wherein the input data includes a combination of different data types of the input data;
using the neural graphical model to perform an inference task to provide an answer to the query; and
outputting a set of values for the neural graphical model based on the inference task for the answer.

13. The method of claim 12, wherein the input data includes real number values, categorical feature values, text input, medical entities, tabular data, time series data, images, captions, objects, videos, audio data, words, phrases, sentences, documents, webpages, or e-mail messages.

14. The method of claim 12, wherein the inference task predicts unknown values based on the neural graphical model and the set of output values is a set of fixed values or a set of distributions over values.

15. The method of claim 14, wherein the inference task uses message passing to determine the unknown values in the set of values for the neural graphical model or a gradient-based approach to determine the unknown values in the set of values for the neural graphical model.

16. The method of claim 12, wherein the neural view includes:
an input layer with features of the domain;
an encoder that compresses the input data to an input embedding;
a neural network with multiple layers;
weights, wherein the weights are applied to each connection between the input layer, the layers, and an output layer;
the output layer with an output embedding; and
a decoder that transforms the output embedding at the output layer to an input data space.

17. A method, comprising:
accessing a neural view of a neural graphical model trained on input data for a domain, wherein the input data includes a combination of different data types of the input data;
using the neural graphical model to perform a sampling task; and
outputting a set of data samples generated by the neural graphical model based on the sampling task.

18. The method of claim 17, wherein the input data includes real number values, categorical feature values, text input, medical entities, tabular data, time series data, images, captions, objects, videos, audio data, words, phrases, sentences, documents, webpages, or e-mail messages.

19. The method of claim 17, wherein the sampling task further comprises:
randomly selecting a node in the neural graphical model as a starting node;
placing remaining nodes in the neural graphical model in an order relative to the starting node; and
creating a value for each node of the remaining nodes in the neural graphical model based on values from neighboring nodes to each node of the remaining nodes by adding random noise to the value created for the node based on a distribution conditioned on the values from the neighboring nodes.

20. The method of claim 17, wherein the neural view includes:
an input layer with features of the domain;
an encoder that compresses the input data to an input embedding;
a neural network with multiple layers;
weights, wherein the weights are applied to each connection between the input layer, the layers, and an output layer;
the output layer with an output embedding; and
a decoder that transforms the output embedding at the output layer to an input data.
